(19) United States
(12) Patent Application Publication
(10) Pub. No.: US 2005/0196515 A1
(43) Pub. Date: Sep. 8, 2005

(54) Food materials

(76) Inventors: Hiroshi Araki, Kakogawa-shi (JP); Sato Araki, Kakogawa-shi (JP)

Correspondence Address: SMITH PATENT OFFICE, 1901 PENNSYLVANIA AVENUE N W, SUITE 200, WASHINGTON, DC, 20006, US

(21) Appl. No.: 10/990,315

(22) Filed: Nov. 17, 2004

(30) Foreign Application Priority Data
Mar. 4, 2004 (JP) 2004-060879

(51) Int. Cl. A23K 1/00

(52) U.S. Cl. 426/615

(57) ABSTRACT

A food material capable of suppressing the ingestion of saccharide (starches) as far as possible to prevent an obesity, diabetes and hyperlipidemia is provided as well as a food product employing the same. The food material contains as main ingredients at least one of a roasted wheat husk powder, roasted oat husk powder and roasted rice bran, gluten and a predetermined amount of a plantain seed skin powder and contains substantially no saccharides (starches). A food product employing this food material is produced by adding milk and yeast to the food material, fermenting the mixture and then baking the mixture in the form of a bread and cookie. The present invention enables an efficacious utilization of a wheat bran and a rice bran which are problematic food material industrial waste.

### BACKGROUND OF THE INVENTION

1. Field of the Invention

The present invention relates to a material capable of being employed in a wide range of healthy foods such as breads, pastas, cookies, pound cakes and the like, which is imparted with a moisturizing ability by employing as its main ingredients at least one of a wheat husk powder (hereinafter refer to as “wheat bran”), oat husk powder and rice bran and a gluten together with a slight amount of a plantain (psyllium) seed skin powder and which contains substantially no starches (saccharides). The term “contains substantially no starches” is based on the understanding that a small residue of a starch in the wheat bran or rice bran as components is considered to be removed as a result of roasting. Furthermore, when a yeast is added to an inventive food material to effect a fermentation, a milk is added and its lactose is utilized.

2. Discussion of the Related Art

While a bread or cookie using a whole flour made of a wheat or oat has been marketed, any of such products enables the ingestion of a relatively large amount of a dietary fiber when compared with a product using a refined flour, but its starch content is almost the same. On the contrary, the present invention is intended not only to utilize fibers, various minerals and vitamins contained in a wheat bran, oat husk powder and rice bran, but also to suppress the ingestion of starches as far as possible by using a product containing no starches.

As emphasized by the WHO (World Health Organization), obesity is prevailing in these days all over the world like an epidemic disease, and leads to an increase in the incidence of cardiovascular diseases, diabetes and hypertension. Since the 1970s, a low calorie and low fat food has been recommended for preventing obesity in the United States. Even though many people have followed this recommendation, the obesity population has continued to increase.

Such a situation is at the basis of suggestion for a healthy eating practice by the U.S. Department of Agriculture, which is represented as a food pyramid, whose bottom (most important food) corresponds to a carbohydrate (60% of the entire eating), on which there exists a protein, on which there exists a fat, showing that the carbohydrate is the most important. Nevertheless, in response to the increase in the ingestion of the carbohydrates (saccharides) as described above and a progressively reduced calorie trend, the high level of obesity has still resulted.

Focusing on such contradicting consequences, Dr. Atkins has emphasized a low carbohydrate diet for about 30 years. Recently, the low carbohydrate diet is increasingly emphasized by researchers other than Dr. Atkins, such as Dr. Agatston proposing the South Beach Diet, and increasing populations have began to stop eating buns of hamburgers, pizzas, and cookies since a debate with regard to this diet was broadcast on TV in May 2003 in the United States. Also in Japan, the number of patients and future patients with obesity and diabetes is increasing rapidly, and the ingestion of saccharides, especially those from a refined wheat flour or polished rice should be restricted more seriously.

### SUMMARY OF THE INVENTION

An objective of the present invention is to provide a food and its starting material that satisfy the following goals in order to prevent obesity, diabetes and hyperlipidemia: to suppress the ingestion of saccharides as far as possible, to increase the ingestion of dietary fibers which tend to be lacking, and to effectively utilize “the wheat bran and the rice bran” which are considered as major food industrial wastes.

In the present invention, the level of the saccharides remaining in a roasted wheat bran, roasted oat husk powder or roasted rice bran becomes substantially zero as a result of the use of a roasted wheat bran, roasted oat husk powder or roasted rice bran, and a gluten which is a vegetable protein is employed as a binder to combine the roasted wheat husk powder, roasted oat husk powder or roasted rice bran. Also in the present invention, in order to avoid a dry texture of a product resulting from the above-mentioned composition, a slight amount of a plantain (psyllium) seed skin powder is added to impart the product with a water-retaining ability and a moisture, whereby accomplishing the objective of the present invention. While a plantain seed skin powder is employed as a laxative agent, it has not been reported to be employed in a food for the purpose of imparting the food with a water-retaining ability.

Thus, a food material according to the present invention is characterized in that its main ingredients are at least one of a roasted wheat bran, roasted oat husk powder and roasted rice bran, gluten and a slight amount of a plantain (psyllium) seed skin powder and it contains substantially no saccharides (starches).

A food according to the present invention is characterized in that it is produced by adding a milk and a yeast to a food material whose main ingredients are either of a roasted wheat bran, roasted oat husk powder and roasted rice bran, gluten and a slight amount of a plantain (psyllium) seed skin powder and which contains substantially no saccharides (starches), fermenting the mixture and then baking the mixture in the form of a bread or cookie.

While the roasted wheat bran, roasted oat husk powder or roasted rice bran may be any commercially available product itself, the roasted wheat bran, roasted oat husk powder or roasted rice bran may be obtained by roasting and then grinding a wheat bran, oat husk powder or rice bran. Each particle size is preferably 40 to 60 mesh size. The ratio (weight ratio) between the roasted wheat bran, roasted oat husk powder or roasted rice bran (hereinafter sometimes abbreviated as “wheat bran and the like”) and the gluten may be about 8:2 to 5:5, but preferably about 6:4 to 3:7.

The plantain seed skin powder is present in an amount of about 0.5 to 5 based on 1000 of the sum (total amount) of the wheat bran and the like and the gluten, preferably about 3 to 5 when using the wheat bran and as low as about 0.5 to 2 when using a rice bran.

A resultant food material is a deep beige powder, and may be combined with a fat, egg and the like to obtain a further improved flavor and nutrition. Such a fat may be a butter or sesame oil, with the butter being preferable for a wheat bran and oat husk powder, while the sesame oil being preferable for a rice bran. Otherwise, cocoa and cinnamon can be used as flavors and non-saccharide sweeteners such as Stevia and Aspartame may also be added as appropriate.

While the food material in the present invention can be combined with water and kneaded, molded and baked to obtain a dry bread, it may be combined with a yeast and a milk and shaped as appropriate while adjusting the hardness and then baked in an oven by an ordinary method to obtain a bread or cookie-like healthy food. In such a case, the primary fermentation and the secondary fermentation of the yeast may be omitted, and maturing at room temperature for about half an hour prior to the baking is sufficient.

A bread or cookie-like food according to the present invention has a texture which is comparable with a conventional product obtained by using saccharides, and serves to reduce the ingestion of the saccharides, and its continuous consumption leads to a reduction in the blood sugar level and also to an improved bowel movement. The food material in the present invention can also be utilized as a material for various food products.

### DETAILED DESCRIPTION OF THE PREFERRED EMBODIMENTS

The present invention is now described in connection with the following examples.

### EXAMPLE 1

1 kg of a 6:4 mixture of a roasted wheat bran and a gluten was combined with 4 g of a plantain seed skin powder, and agitated vigorously to obtain a deep beige powdery food material.

### EXAMPLE 2

1 kg of a 6:4 mixture of a roasted oat husk powder and a gluten was combined with 4 g of a plantain seed skin powder, and agitated vigorously to obtain a deep beige powdery food material.

### EXAMPLE 3

1 kg of a 5:5 mixture of a roasted rice bran and a gluten was combined with 1 g of a plantain seed skin powder, and agitated vigorously to obtain a deep beige powdery food material.

### EXAMPLE 4

1 kg of a 4:6 mixture of a roasted rice bran and a gluten was combined with 1 g of a plantain seed skin powder, and agitated vigorously to obtain a deep beige powdery food material.

### EXAMPLE 5

1 kg of a 3:7 mixture of a roasted rice bran and a gluten was combined with 1 g of a plantain seed skin powder, and agitated vigorously to obtain a deep beige powdery food material.

### EXAMPLE 6

100 Parts (parts by weight, the same applies analogously hereinafter unless otherwise specified) of a food material obtained similarly to Example 1 was combined with 3 parts of a yeast, a whole egg (one egg per 100 g of the food material, the same applies analogously hereinafter) and 10 parts of a butter, shaped appropriately while adjusting the hardness using a milk (amount employed: 90 parts by volume), kept at room temperature (25° C.) for 30 minutes, and baked in an oven (200 to 210° C.) for 10 minutes to obtain a deep brown bread-like healthy food.

### EXAMPLE 7

100 Parts (parts by weight, the same applies analogously hereinafter unless otherwise specified) of a food material obtained similarly to Example 2 was combined with 3 parts of a yeast, a whole egg (one egg per 100 g of the food material, the same applies analogously hereinafter) and 10 parts of a butter, shaped appropriately while adjusting the hardness using a milk (amount employed: 90 parts by volume), kept at room temperature (25° C.) for 30 minutes, and baked in an oven (200 to 210° C.) for 10 minutes to obtain a deep brown bread-like healthy food.

### EXAMPLE 8

100 Parts of a food material obtained similarly to Example 3 was combined with 3 parts of a yeast, a whole egg and 10 parts by volume of a sesame oil, shaped appropriately while adjusting the hardness using a milk (amount employed: 80 parts by volume), kept at room temperature for 30 minutes, and baked in an oven (200° C.) for 11 minutes to obtain a deep brown cookie-like healthy food.

### EXAMPLE 9

100 Parts of a food material obtained similarly to Example 4 was combined with 3 parts of a yeast, a whole egg and 10 parts of a butter, shaped appropriately while adjusting the hardness using a milk (amount employed: 90 parts by volume), kept at room temperature for 30 minutes, and baked in an oven (210° C.) for 12 minutes to obtain a deep brown cookie-like healthy food.

### EXAMPLE 10

100 Parts of a food material obtained similarly to Example 5 was combined with 3 parts of a yeast, a whole egg and 10 parts by volume of a sesame oil, shaped appropriately while adjusting the hardness using a milk (amount employed: 80 parts by volume), kept at room temperature for 30 minutes, and baked in an oven (205° C.) for 10 minutes to obtain a deep brown cookie-like healthy food.

### INDUSTRIAL APPLICABILITY

The present invention provides a healthy food and its starting material that satisfy the following goals in order to prevent obesity, diabetes and hyperlipidemia: to suppress the ingestion of saccharides as far as possible, to increase the ingestion of dietary fibers which tend to be lacking, and to effectively utilize “the wheat bran and the rice bran” which are considered as major food industrial wastes.

This application is based on Japanese Patent Application No. 2004-060879 filed in Japan on Mar. 4, 2004, the contents of which are incorporated hereinto by reference.

1. A food material whose main ingredients are at least one of a roasted wheat husk powder, roasted oat husk powder and roasted rice bran, gluten and a predetermined amount of a plantain seed skin powder, and wherein substantially all of the saccharides are removed.

2. A food material as defined in claim 1, wherein the weight ratio between at least one of the roasted wheat husk powder, roasted oat husk powder and roasted rice bran, and the gluten is 8:2 to 5:5.

3. A food material as defined in claim 2, wherein the weight ratio between at least one of the roasted wheat husk powder, roasted oat husk powder and roasted rice bran, and the gluten is 6:4 to 3:7.

4. A food material as defined in claim 1, wherein the plantain seed skin powder content is 0.05 to 0.5% by weight based on the total amount of at least one of the roasted wheat husk powder, roasted oat husk powder and roasted rice bran, and the gluten.

5. A food material as defined in claim 1, wherein the plantain seed skin powder content is 0.3 to 0.5% by weight based on the total amount of at least one of the roasted wheat husk powder and roasted oat husk powder, and the gluten.

6. A food material as defined in claim 1, wherein the plantain seed skin powder content is 0.05 to 0.2% by weight based on the total amount of the roasted rice bran and the gluten.

7. A food material as defined in claim 1, wherein the roasted wheat husk powder, roasted oat husk powder and roasted rice bran is a particle of 40 to 60 mesh.

8. A food material as defined in claim 1, which further contains a fat.

9. A food material as defined in claim 8, wherein said fat is at least one of a butter and sesame oil.

10. A food product comprising at least one of a roasted wheat husk powder, roasted oat husk powder and roasted rice bran, gluten, and a predetermined amount of a plantain seed skin powder, a milk, and a yeast.

11. A food product providing at least one of a roasted wheat husk powder, roasted oat husk powder and roasted rice bran, gluten, and a predetermined amount of a plantain seed skin powder, a milk, and a yeast, and made by combining the above to form a mixture, fermenting, and baking the mixture.

12. A food product as defined in claim 11, wherein said at least one of a roasted wheat husk powder, roasted oat husk powder, and roasted rice bran is a roasted wheat husk powder, and the roasted wheat husk powder and gluten are in 6:4 ratio.

13. A food product as defined in claim 11, wherein said at least one of a roasted wheat husk powder, roasted oat husk powder, and roasted rice bran is a roasted oat husk powder, and the roasted oat husk powder and gluten are in 6:4 ratio.

14. A food product as defined in claim 11, wherein said at least one of a roasted wheat husk powder, roasted oat husk powder, and roasted rice bran is a roasted rice bran, and the roasted rice bran and gluten are in 5:5 ratio.

15. A food product as defined in claim 11, wherein said at least one of a roasted wheat husk powder, roasted oat husk powder, and roasted rice bran is a roasted rice bran, and the roasted rice bran and gluten are in 4:6 ratio.

16. A food product as defined in claim 11, wherein said at least one of a roasted wheat husk powder, roasted oat husk powder, and roasted rice bran is a roasted rice bran, and the roasted rice bran and gluten are in 3:7 ratio.

17. A food product as defined in claim 11, wherein said at least one of a roasted wheat husk powder, roasted oat husk powder, and roasted rice bran is combined with a yeast, a whole egg, and a butter, and shaped appropriately while adjusting the hardness using a milk.

18. A food product as defined in claim 11, wherein said at least one of a roasted wheat husk powder, roasted oat husk powder, and roasted rice bran is combined with a yeast, a whole egg, and a sesame oil, and shaped appropriately while adjusting the hardness using a milk.

19. A food product as defined in claim 11, wherein said step of fermenting includes keeping the mixture at room temperature for approximately 30 minutes.

20. A food product as defined in claim 11, wherein said step of baking includes baking the mixture in an oven at temperature between 200° C. and 210° C. for 10-12 minutes.
